(19) United States
(12) Patent Application Publication
(10) Pub. No.: US 2009/0010189 A1
(43) Pub. Date: Jan. 8, 2009

(54) Network with remaining battery life routing metric

(76) Inventors: Sundeep S. Nagra, Roseville, CA (US); Scott Douglas Crippin, Roseville, CA (US); Deepak Patil, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/825,351

(22) Filed: Jul. 7, 2007

(51) Int. Cl. G08C 17/02

(52) U.S. Cl. 370/311

(57) ABSTRACT

A method includes providing a plurality of communicatively coupled sensor nodes including a destination node. A first selected path from an originating node to the destination node is determined from any plurality of possible paths based on a cost of the first selected path. The cost of any path is based at least in part on a cumulative function of the remaining battery life for each sensor node in that path.

### BACKGROUND

Packet-based communication networks typically provide more than one route for forwarding packets to their intended destination. This allows for robust communications because packets can be forwarded around defective nodes or problematic links between network nodes. Even in the absence of defective nodes or problematic links, the existence of multiple paths allows for discriminating between paths based upon some attribute of the path.

In some applications the network nodes may be battery-powered. Batteries enable mobility of the nodes because nodes no longer need to be tethered to line power. Mobile nodes find applications in ad hoc networks for emergency/rescue and military operations, for example. Aside from serving to forward communications from other nodes towards a destination node, the nodes may provide sensing functionality. Such nodes are known as “motes”.

Mote networks suffer from the limitations of the batteries. Replacing the batteries may be difficult or impossible. The batteries may have differing useful lives left. As the batteries fail, so do the motes.

One approach to conserving battery life is to reduce the periodicity with which the motes transmit sensed data. Such a reduction in monitoring conserves energy by reducing how often the mote senses and transmits data. Although this approach conserves power, it decreases the usefulness of the sensor network.

Another approach to conserving battery life is the use of routing metrics to minimize -the power consumed for communications. The nodes along the most energy efficient paths would tend to bear the brunt of all communications. This approach might lead to maximizing the life of at least one network route such that there is at least one route for active sensors to forward communications to the destination.

One disadvantage of this approach is the loss of value due to an incomplete sensor network. In other words, this approach focuses on ensuring a path to forward the information that is collected, but the amount of information collected may be severely curtailed by the loss of motes whose power was “cannibalized” through the avoidance of other nodes to ensure longevity of a communication route. For some applications, the existence of a few motes forming a route is of little value in the absence of an extensive sensor network.

### SUMMARY

Various embodiments of methods and apparatus for routing communications among a plurality of nodes are described. In one embodiment, a method includes providing a plurality of communicatively coupled sensor nodes including a destination node. A first selected path from an originating node to the destination node is determined from any plurality of possible paths based on a cost of the first selected path. The cost of any path is based at least in part on a cumulative function of the remaining battery life for each sensor node in that path.

In another embodiment, an apparatus includes a plurality of communicatively coupled sensor nodes including a destination node. Each sensor node includes a processor. The processor selects a first selected path from an originating node to the destination node from any plurality of possible paths based on a cost of the first selected path. The cost of any path is based at least in part on a cumulative function of the remaining battery life for each node in that path.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a network.

FIG. 2 illustrates one embodiment of a sensor node (“mote”).

FIG. 3 illustrates one embodiment of a method of estimating a remaining battery life.

FIG. 4 illustrates one embodiment of a sensor node network modeled as a directed graph.

FIG. 5 illustrates lowest cost paths for one embodiment of a sensor node network having a routing metric based exclusively on remaining battery life.

FIG. 6 illustrates lowest cost paths for one embodiment of a sensor node network having a routing metric based exclusively on remaining battery life.

FIG. 7 illustrates lowest cost paths for one embodiment of a sensor node network having a routing metric based on remaining battery life and path length.

FIG. 8 illustrates one embodiment of a method of selecting channels for networked nodes.

FIG. 9 illustrates one embodiment of a method of selecting a path from an originating node to a destination node based at least in part on a cumulative function of the remaining battery life for each sensor node in the path.

FIG. 10 illustrates one embodiment of a method of determining a first selected path from an originating node to a destination node based at least in part on a cumulative function of the remaining battery life for each sensor node in the path.

FIG. 11 illustrates one embodiment of a method of communicating a packet from the next node of the first selected path to the next node of a second selected path.

### DETAILED DESCRIPTION

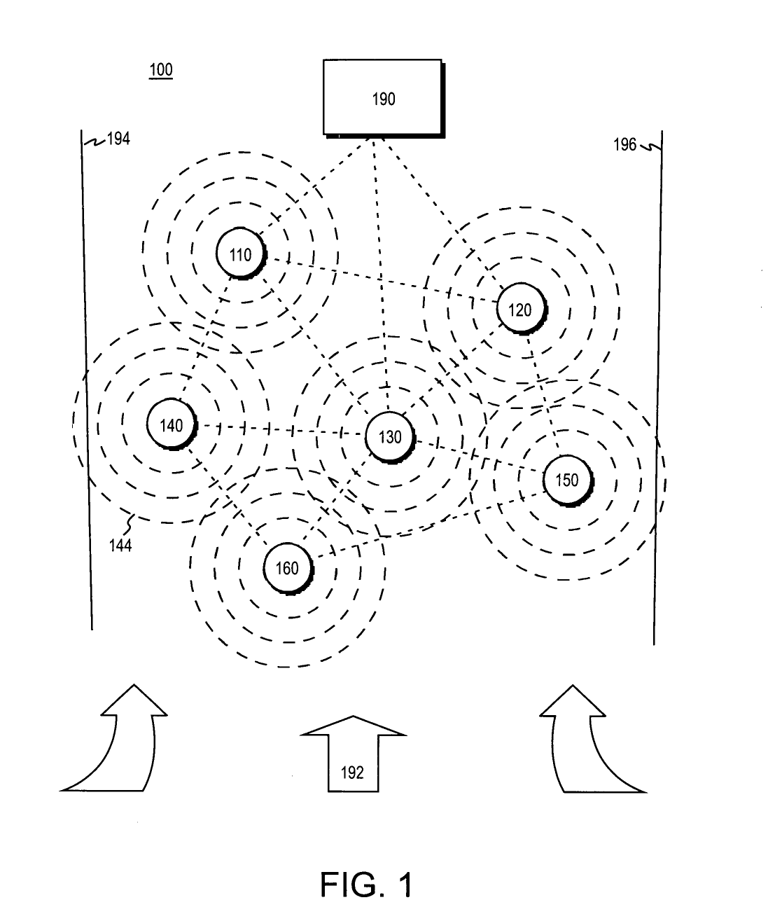

FIG. 1 illustrates a network 100 including a plurality of communicatively coupled nodes 110, 120, 130, 140,150,160, and 190. In one embodiment, the network is a packet-based network.

Although the network may be an “intranet” designed primarily for access between computers within a private network, in one embodiment network 100 represents a portion of the network commonly referred to as the Internet. These nodes may include routers, switches, hubs, repeaters, gateways, bridges, and communications links. In addition to any such network functionality, at least a plurality of nodes 110, 120, 130, 140, 150, and 160 function as sensors.

In the illustrated embodiment, the network nodes include a destination node 190. Destination node 190 may also function as a sensor. The destination node collects the data from the networked sensor nodes to process or forward to another location.

In some applications these sensors must rely upon battery power for operation. Such battery powered sensors are sometimes referred to as remote sensors or simply “motes”.

The term “battery” is intended to describe an apparatus that exhibits a profiled energy (joule) or charge (amp hour) level in response to consumption over time. Thus a capacitor, for example, may be considered to function as a battery for this application. The remaining battery life can be measured or estimated from the profile.

Motes may be particularly suitable for emergency/rescue, disaster relief, or military applications to name a few. Such a network may be designed for a disposable network or a temporary use. In one embodiment, the nodes communicate wirelessly to facilitate expediency and flexibility in establishing a sensor network.

The type of sensing performed may vary depending upon the application. The sensors will typically be measuring one or more environmental elements to determine physical characteristics or attributes of the environment about a given location. The location may be dynamically changing or static. The location may be defined as a two-dimensional, three-dimensional, or otherwise multi-dimensional space. For example, sensor nodes carried aloft by balloons may change absolute position as well as relative position as they drift in relative altitude and distance to each other.

The number and category of environmental elements to be sensed may vary upon the intended application. Groups of environmental elements are frequently categorized for convenience into classifications such as meteorological, marine, hydrological, etc. Air temperature, pressure, wind speed, wind direction, probability and amount of precipitation, humidity, cloud cover, and visibility are a subset of environmental elements generally grouped as meteorological elements. Marine elements might include water temperature, wave height, wave direction, etc.

Examples of other environmental elements might include heat index, wind chill, drought index, soil moisture, aerosol dispersion, ranges of electromagnetic radiation, earth movement, sound, vibration, motion, etc. The electromagnetic radiation may include one or more of radio, microwave, infrared, visible light, ultraviolet, X-ray, or gamma ray radiation. The sensors may even simply detect the presence of a pre-determined element.

For example, a wildlife scientist might utilize sensors designed to detect the presence of a sound attributable to a specific animal species. A military advisor might need to know about any activity in a particular geographic area. Characteristics of ground vibrations might indicate whether activity is attributable to individual troops or heavy weaponry such as tanks.

Generally, the number and category of environmental elements needed to define the environmental state vary upon the intended application. Reliable sensing and communication of the environmental state is useful for planning a wide range of activities for any number of entities including government, military, consumer, and other commercial enterprises.

For some applications, the value of the sensed data decreases rapidly as the number of sensor nodes decreases. The number of sensor nodes may decrease as the batteries are depleted. These failing sensors result in gaps in sensor coverage of an area as well as failed network nodes. The act of forwarding communications inherently decreases the remaining useful life of the node and hence for some applications the value of the data provided by the remaining network as a whole.

Referring to FIG. 1, consider network 100 with sensors 110-160 configured to detect motion or movement. Such information might be useful to identify animal, people, machinery, or some other monitored mass advancing towards the destination node 190 as illustrated by arrow 192. In the illustrated embodiment, circumnavigation of the nodes is limited by walls or terrain 194, 196.

Each sensor 140 has a scope of sensor coverage 144. This coverage may overlap but need not cover the same area over which a sensor node may communicate with another sensor node.

Typically, the range within which the sensor node may communicate as well as the scope or area of coverage of the sensor tends to decrease as the node's battery-power wanes. A failure of node 130 may result in failure to detect movement directly toward the destination node 190. Failure or impairment of nodes 140, 160 might permit undetected circumvention of the sensor network. Such gaps in coverage can undesirably lead to false conclusions about movement due to the gaps in sensor coverage. In particular, the data provided by the sensor network might indicate that no movement is present when in fact movement is present and undetected because of its occurrence within the gaps in coverage. The value of the network may thus be significantly compromised as a result of “gaps” which arise from failing or failed nodes.

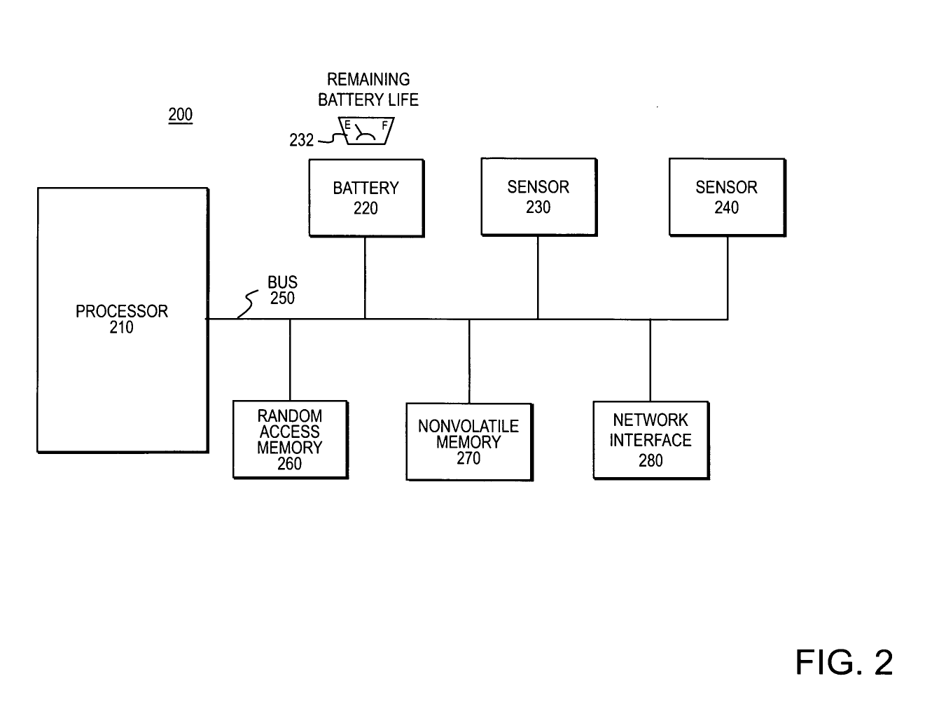

FIG. 2 illustrates one embodiment of a sensor node 200. The node includes a processor 210, a power supply subject to depletion such as a battery 220, one or more sensors 230, 240, and a network interface 280. Sensor node 200 includes random access memory (RAM) 260 used by the processor during program execution. RAM 260 is typically a volatile memory and does not retain its contents once power is removed from the sensor node. Routing tables describing the reachability of other nodes of the network may be stored in RAM 260.

Sensor node 200 includes nonvolatile memory 270 for storing configuration settings even when the sensor node is powered down. These configuration settings might describe the amount of RAM, characteristics about sensors 230, 240, battery 220, or the network interface 280, for example. The nonvolatile memory may also store any program code required for sensor node operations and communications via the network interface 280.

In one embodiment, nonvolatile memory 270 is a semiconductor-based memory. Various types of nonvolatile media including electrically erasable programmable read only memory (EEPROM), flash electrically rewritable memory, and battery-backed complementary metal oxide semiconductor (CMOS) are available.

Sensors 230, 240, RAM 260, nonvolatile memory 270, and network interface 280 are communicatively coupled to the processor 210 through one or more buses such as bus 250. The battery supply may similarly be distributed to the other components by one or more busses such as bus 250. In alternative embodiments, power and communication are handled by distinct busses.

At least one of the values that may be communicated by the sensor node is the remaining battery supply 232. This might be communicated as a percentage. In other embodiments, the value is proportional to the remaining battery life of the battery as opposed to the fully charged battery life. The value, for example, may represent joules or amp-hours. The one or more sensors 230, 240 collect information about the environment around the sensor node for processing.

In order to forward communications to a destination, the communications may have to pass through one or more other sensor nodes. The route to be taken from the origination node to the destination node is guided by a routing metric. The nodes exchange routing table information about the reachability of other nodes and the “cost” to reach those nodes. The routing tables may be stored in RAM 260.

Two classifications of routing protocols are link-state routing and distance-vector routing. In a typical network, factors contributing to the cost include path length (i.e., number of hops to destination), congestion, speed, etc. The protocol generally describes how frequently routing information is exchanged between nodes, the contents of the exchanged routing information, triggering events for exchanging routing information, etc.

Link-state routing calculate lowest cost paths based upon cost factors defined by the routing metric. Dijkstra's algorithm is a well-known method of determining the lowest cost path in view of the routing metric. Link-state nodes typically only update other connected nodes with routing tables when the link-state node's own routing table changes.

Distance-vector routing typically considers a single metric such as hop count and periodically communicate routing tables to neighboring nodes. Common approaches to distance-vector routing utilize the well-known Bellman-Ford or Ford-Fulkerson algorithms.

In an effort to distribute the longevity of the network as a whole, the remaining battery life of the sensor nodes is incorporated into the routing metric. Traditional routing metrics tend to minimize cost. In the present case, however, the metric is to route communications from a source node to a destination node selecting nodes having the most remaining battery life where possible. This approach is not simply the converse of a minimization approach because there is no convergence to a maximum when the cost can be increased by simply traversing cycles of the graph (i.e., traversing the same node more than once). Accordingly, the cost function should increase as remaining battery life decreases.

The act of initiating and forwarding communications inherently consumes a portion of the remaining battery life of the initiating and forwarding nodes. If the sole routing metric is “shortest path”, then the deleterious effects of forwarding may be concentrated among fewer sensor nodes particularly if there is a relatively small number or even a single destination node. This in turn would tend to contribute to rapid deterioration of contiguous areas of sensor coverage. The effectiveness and value of the sensor node network can be compromised for some applications even though there may be ample battery life left in many sensor nodes.

In one embodiment, the routing metric is a function only of the remaining battery life (bᵢ). For example, in one embodiment, the cost associated with each node is

$${c}_{i} ( {b}_{i} ) = \frac{W 1}{{b}_{i}}$$

where W1 is a weight constant, and bᵢ is the remaining battery life associated with a given node i. To avoid divide-by-zero errors, cᵢ(bᵢ) can simply set to a pre-determined value selected to deter choosing that hop as the remaining battery life wanes. In another embodiment,

$${c}_{i} ( {b}_{i} ) = \frac{W 1}{{b}_{i} + K} .$$

where K is selected to ensure cᵢ(bᵢ) is constrained as bᵢ approaches zero.

In another embodiment,

cᵢ(bᵢ)=Mᵢ−bᵢ

where Mᵢ is greater than or equal to the maximum battery capacity for that node to ensure non-negative values for cᵢ(bᵢ). The cost function becomes a measure of the loss of battery life. If the sensor nodes use the same batteries throughout, then Mᵢ may be set to the same constant value for any edge i for any selected path. The sensor node may choose a selected path corresponding to the least cost path from an origination node to a destination node. In particular, the cost Cₛ of any selected path s is defined by

$${C}_{s} = {\sum }_{i = 1}^{n} {c}_{i} ( {b}_{i} )$$

In alternative embodiments, the cost for each selected path may be a function of at least two variables including the path length (n) and the remaining battery life. In one embodiment, the routing metric is defined generally as follows:

$${C}_{s} = n W 2 + {\sum }_{i = 1}^{n} {c}_{i} ( {b}_{i} )$$

where W2 represents a weight constant and n represents the path length in terms of the number of hops.

Generally the cost function is chosen such that Cₛ increases with either increases in the number of hops or decreases in the remaining battery life. In one embodiment, the objective of any routing algorithm within a given sensor node is to select the path having the minimum Cₛ relative to the Cₛ associated with any other path of the plurality of selectable paths. Given that the communicative coupling, remaining battery life, and even the existence of sensor nodes are dynamically changing factors, communications may ultimately be forwarded along links and nodes that do not belong to the path selected by the originating node.

As the remaining battery life of a given node decreases relative to that of other nodes, the routing metric will tend to avoid the given node when forwarding communications from the other nodes to another destination node when possible (i.e., assuming there are alternative routes that do not include the given node). The remaining battery life may be incorporated into either link-state networks or distance-vector routing protocols as the case may be. The nodes must have the capability of sensing remaining battery life, however, in order to communicate that information to other nodes.

In various embodiments, the value utilized for the remaining battery life may be expressed in absolute values or as percentages of capacity (e.g., 0.8). The value may be expressed as an energy level (e.g., 800 joules) or charge level (e.g., 10 amp hours). For some applications, the value may be expressed as a supply level (e.g., 10 volts). Although the remaining battery life may be sensed in one embodiment, an estimate of the remaining battery life may be computed.

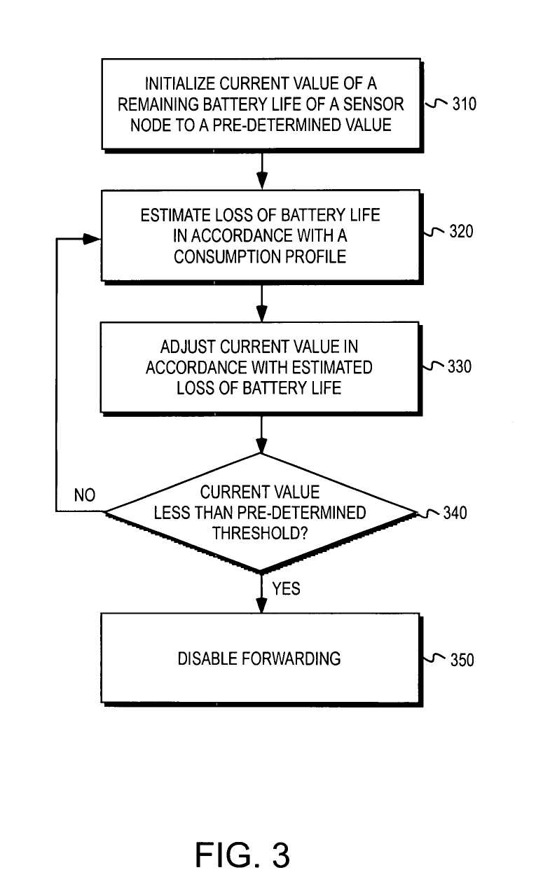

FIG. 3 illustrates one embodiment of a method of estimating a remaining battery life. In step 310, the remaining battery life of a sensor node is initialized to a pre-determined value as a current value.

In step 320, an estimated loss of battery life is determined in accordance with a consumption profile. The transmission power, duration of transmission, receiver power, duration that receiver is enabled, and processor run time are significant contributers to the consumption profile. The number of packets transmitted may be a suitable indicator for measuring power consumption.

In step 330, the current value is adjusted in accordance with the estimated loss of battery life to reflect the remaining battery life. In one embodiment, the current value is decremented by the estimated loss of battery life. In one embodiment, steps 320-330 repeat until the battery is depleted.

Alternatively, the sensor node may disable forwarding in order to preserve the ability to communicate its own sensed data as long as possible. If the remaining battery life is less than a pre-determined threshold as determined by step 340, then the sensor node mode is changed to prohibit forwarding in step 350. Steps 320-350 repeat until the battery is depleted or replaced.

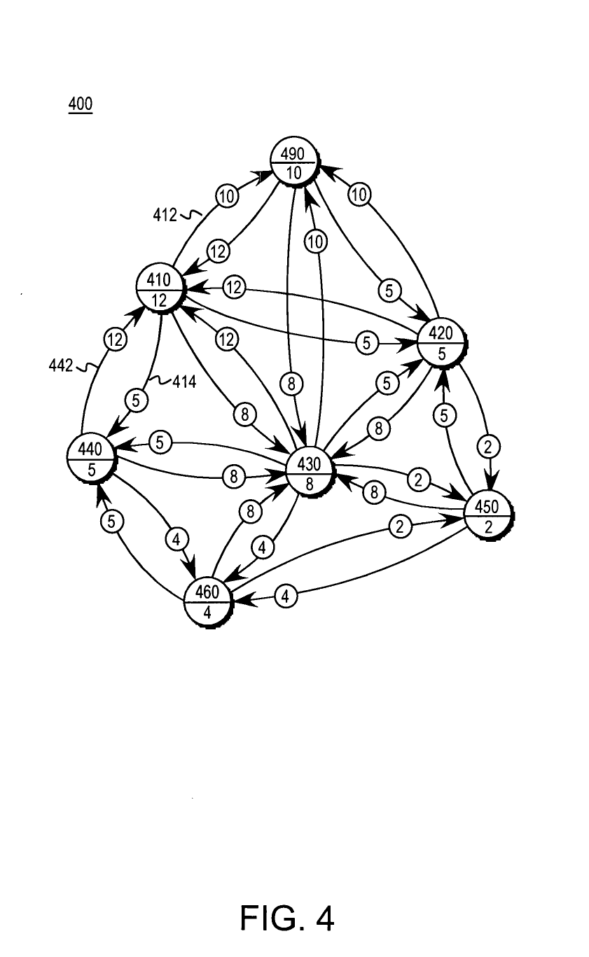

The sensor node network may be modeled as a graph 400 as illustrated in FIG. 4. In one embodiment, graph 400 is a directed graph. Each sensor node 410, 420 corresponds to a vertex and the links between vertices are referred to as edges 412, 414, 442 in the graph context. Vertices connected by an edge are termed adjacent. The remaining battery life is indicated for each node/vertex. The edges represent a communications link between adjacent nodes.

Although communications between sensor nodes may be bi-directional, the graph must take into account that the remaining battery life for the sensors will vary. There is no cost associated with the originating node in computing the cost of the selected path. The cost of the destination node may or may not be included. Accordingly a path can have a different cost depending upon direction traveled.

For example, the cost of forwarding from vertex 410 to vertex 440 is different than the cost of forwarding from vertex 440 to vertex 410. For illustration, the cost of traveling from vertex 410 along edge 414 to vertex 440 has the value 5 in accordance with the remaining battery life cost of 5 for vertex 440. The cost of traveling from vertex 440 along edge 442 to vertex 410 is 12 in accordance with the remaining battery life cost of 12 for vertex 410. Relatively lower costs reflect relatively greater remaining battery life. The forwarding cost of a vertex is shown on the edge leading to that vertex for purposes of illustration.

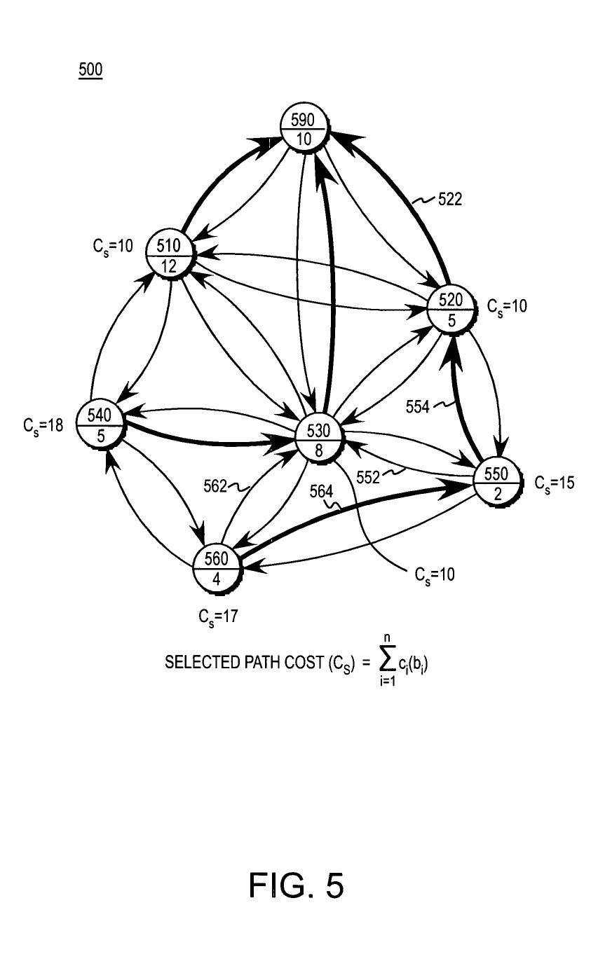

FIG. 5 illustrates lowest cost paths from vertices 510, 520, 530, 540, 550, and 560 to destination vertex 590 for sensor node network 500 when the routing metric is based exclusively on remaining battery life (e.g.,

$${C}_{s} = {\sum }_{i = 1}^{n} {c}_{i} ( {b}_{i} ) \text{)} .$$

The lowest cost paths are represented by bold edges. The cumulative cost is indicated next to each vertex. Note that the lowest cost path to the destination vertex from vertex 550 includes edge 552, vertex 520, and edge 522. The lowest cost path to the destination vertex from 560 includes edge 564, vertex 550, edge 552, vertex 520, and edge 522.

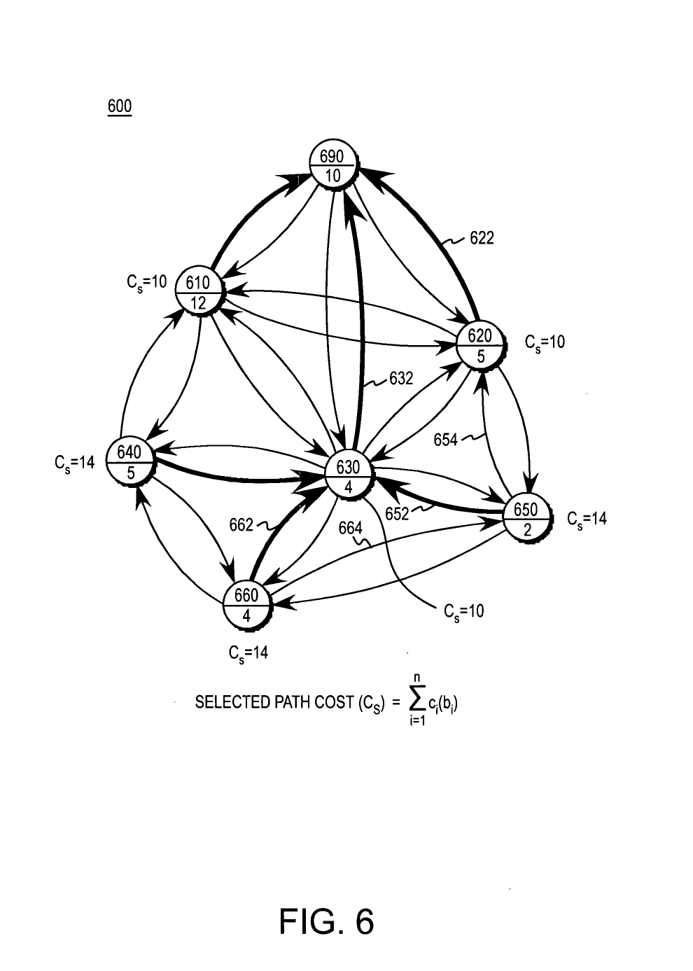

FIG. 6 illustrates lowest cost paths from nodes 610, 620, 630, 640, 650, and 660 to destination vertex 690 for sensor node network 600 when the routing metric is based exclusively on remaining battery life. In particular, FIG. 6 illustrates the change in paths as the remaining battery life changes. The cumulative cost based solely on a remaining battery life metric is indicated next to each vertex.

An increase in remaining battery life indicated by a decrease in the cost of vertex 630 results in re-routing of paths when compared to the corresponding directed graph of FIG. 5. In particular, the next node or vertex from vertex 650 become 630 rather than vertex 620. The lowest cost path from vertex 650 includes edge 652, vertex 630, and edge 632. Edges 654, 622 and vertex 620 are no longer part of the path to the destination vertex.

The next node or vertex from vertex 660 becomes vertex 630 rather than vertex 650. The lowest cost path from vertex 660 includes edge 662, vertex 630, and edge 632. Edge 664, vertex 650, edge 654, vertex 620, and edge 622 are no longer part of the path to the destination. Clearly the reduction in cost of vertex 630 resulted in a different lowest cost paths for several originating nodes.

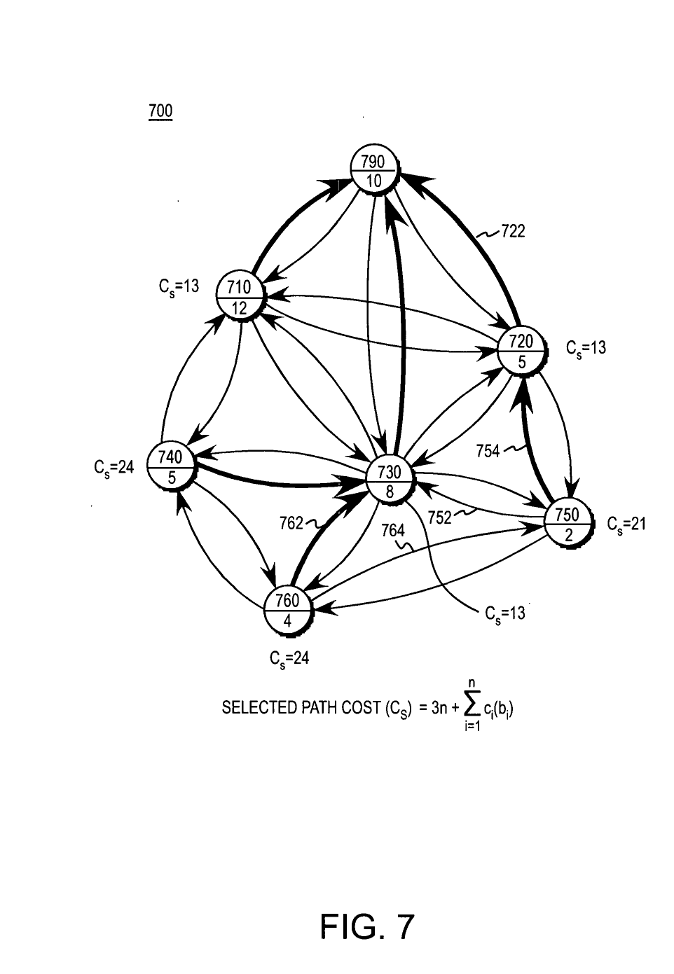

FIG. 7 illustrates lowest cost paths from nodes 710, 720, 730, 740, 750, and 760 to destination vertex 790 for sensor node network 700 when the routing metric includes path length and remaining battery life. The cost of any selected path from an origination vertex to a destination vertex is defined as follows:

$${C}_{S} = 3 n + {\sum }_{i = 1}^{n} {c}_{i} ( {b}_{i} )$$

where a weighted path length (n) is added to the cumulative remaining battery life for all vertices along the selected path.

The remaining battery life for each vertex illustrated in FIG. 7 is identical to the remaining battery life of the corresponding vertices of FIG. 5. The least cost path associated with some of the vertices has changed as a result of the change in routing metric. In particular, the least cost path for vertex 760 includes edge 762, vertex 730, and edge 732. The next node or vertex from vertex 760 become vertex 730 rather than vertex 750. Edge 764, vertex 750, edge 754, edge 720, and edge 722 are not part of the lowest cost path from vertex 760 to destination vertex 790 under this routing metric.

The vertices and edges correspond to sensor nodes and lines. Comparison of FIGS. 5, 6, and 7 illustrate the impact of choice of routing metric on the sensor node network.

Thus factors in addition to remaining battery life may be incorporated into the routing metric. Examples of other factors that may be considered include path length, reliability, bandwidth, load, economic cost, delay, and channel noise. Path length is typically expressed as the number of hops to the destination node.

Reliability refers to the dependability of the communication link or node. Reliability may be represented as an error rate. Reliability may reflect how often the link is incapacitated or how quickly the link can be re-established.

Delay refers to the delay from a given node to the destination node. Delay is a measured result of several other factors such as load, bandwidth, etc. Load refers to the degree to which a node is being utilized. The volume of packets per unit time or processor utilization are various ways to measure load.

Economic cost may be a consideration if the sensors communicate using mediums of varying economic cost (e.g., wireless vs. dedicated wired). Bandwidth refers to the available capacity or packet throughput of a link.

The nodes may have the capability to select channels used to communicate with each other. Noisy channels tend to result in a faster depletion of remaining battery life. Nodes may have to increase transmission power in order to overcome channel noise. Alternatively, channel noise may cause a number of dropped packets and subsequent re-transmission of packets. In one embodiment, the nodes are configured to select channels efficiently upon initialization in order to extend the longevity of the network. Channel selection may occur upon a power cycle. Such a cycle may occur whenever a node is turned “on” or whenever batteries are replaced, for example.

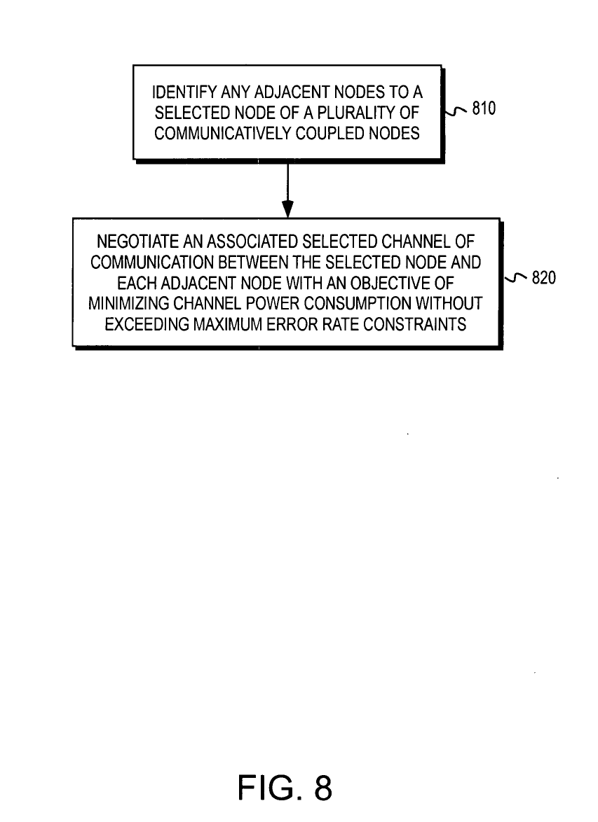

FIG. 8 illustrates one embodiment of a method of selecting channels. Adjacent nodes to a selected node of a plurality of communicatively coupled nodes are identified in step 810. An associated selected channel of communication between the selected node and each adjacent node is negotiated with the objective of minimizing channel power consumption without exceeding maximum error rate constraints in step 820. The same channel may be utilized for communicating with multiple adjacent nodes.

Although channel selection is not related to routing metric, proper channel selection can improve the energy efficiency and thus the longevity of the network as a whole when used in conjunction with a routing metric based at least in part on remaining battery life.

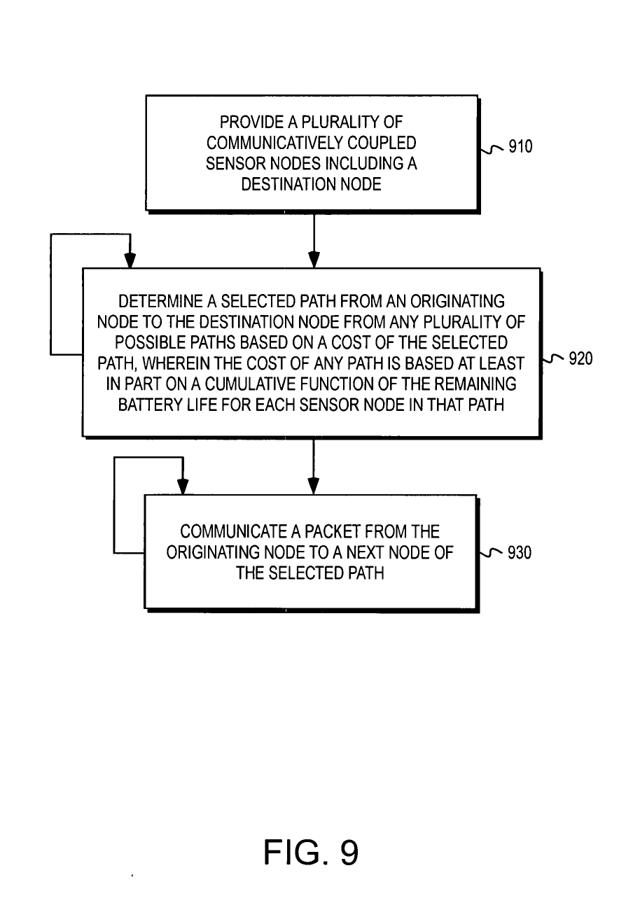

FIG. 9 illustrates one embodiment of a method of selecting a path from an originating node to a destination node. A plurality of communicatively coupled sensor nodes including a destination node is provided in step 910. A selected path from an originating node to the destination node from any plurality of possible paths is determined based on the cost of the selected path in step 920. The cost of any path is based at least in part on a cumulative function of the remaining battery life of each sensor node in that path. Step 920 is generally continuously being performed. As previously described the routing metric may also include path length, delay, economic cost, reliability, load, bandwidth, or other metric. A packet of sensed data is communicated from the originating node to a next node of the selected path in step 930. Step 930 is likewise generally continuously being performed.

Although illustrated in in-line step form, the sensing and routing are independent processes for the sensor node. A selected path must be defined prior to communicating a packet from an originating node, however steps 920 and 930 execute substantially independently. The selected path may dynamically change as the remaining battery life of the networked sensor nodes change.

Although subsequent nodes in a path merely forward packets from an originating node, these forwarding nodes may be treated as origination nodes for purposes of path determination. In particular, each node in a path subsequent the origination node will determine its own lowest cost path to the destination node. The lowest cost path from the forwarding node may or may not match the remainder of the path identified by the originating node. The remaining battery life of the sensor nodes is dynamic in nature. The connectedness of the network is also dynamic because links may be disrupted, sensor nodes may become unavailable, and the remaining battery life of the sensor nodes is changing with respect to each other.

Referring to FIGS. 5 and 6, let vertices 560 and 660 represent an originating sensor node. Vertices other than destination nodes 590, 690 represent prospective forwarding nodes for the illustrated network. The path from vertex 560 to the destination vertex 590 follows edge 564, vertex 550, edge 554, vertex 520, and edge 522 to the destination vertex. If the remaining battery life of the vertices stays the same and the “connectedness” of the network remains the same, then the path P₅₅₀ from the forwarding node 550 is a proper subset of the path P₅₆₀ from the originating node 560 (i.e., P₅₅₀ ⊂P₅₆₀ such that each element of P₅₅₀ is found in P₅₆₀ but there is at least one element of P₅₆₀ that is not found in P₅₅₀).

The routing tables within the nodes are dynamically updated to reflect the changing state of the remaining battery lives. The network may transition from the state illustrated in FIG. 5 to the state illustrated in FIG. 6. The routing tables of nodes 550 and 560 may not be updated at the same time. The nodes may thus have differing views of the network for various reasons. The view that node 560 has of the network may be consistent with FIG. 5 while the view that node 650 has of the network is consistent with FIG. 6.

In any event, node 560 may send a packet to node 550 based upon node 560's view of the network state and the least cost path to destination node 590 of FIG. 5. If FIG. 6 reflects corresponding node 650's view of the network, the least cost path from node 650 to destination node 690 is not the same as the path from node 550 to destination node 590.

Any packet received from node 660 by node 650 will be forwarded along the path defined by edge 652, node 630, and edge 632 to destination node 690. Thus the lowest cost path P₆₅₀ need not be a subset of the lowest cost path P₆₆₀ even if node 650 is a member of path P₆₆₀ or that of its counterpart node P₅₆₀. This is because the network state can change or because the routing tables of the nodes do not reflect the same network state at the time each is communicating the packet to the next node along the path to the destination node.

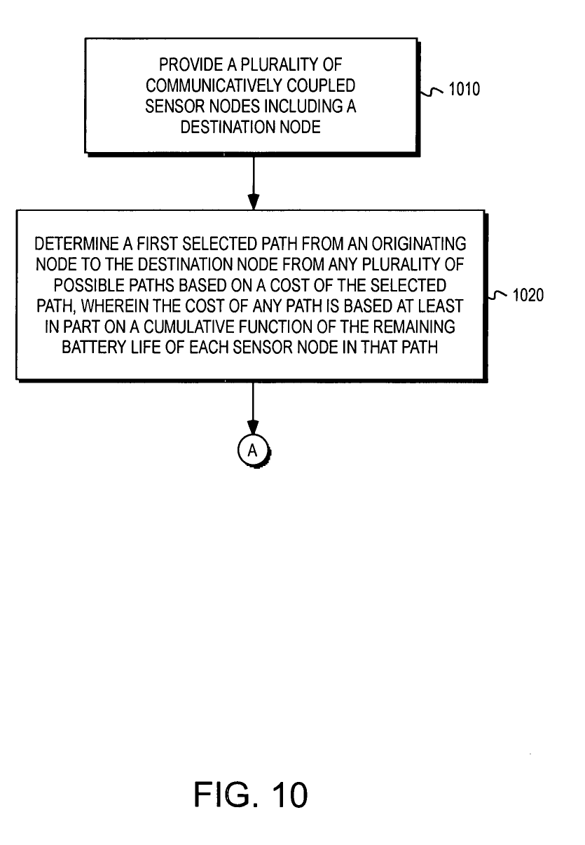

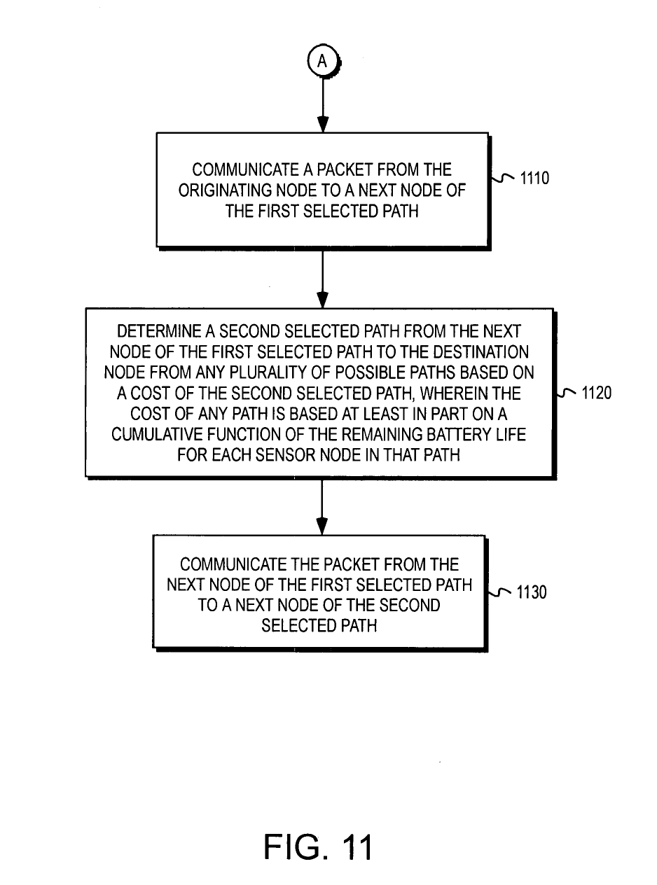

In summary, the path P₆₅₀ from a given node 650 to the destination node need not be a subset of the path P₆₆₀ from a given node 660 to the destination node even if node 650 is a member of the least cost path defined by node 660 (comparing counterparts in FIGS. 5 and 6). Referring only to FIG. 6, path P₆₅₀ need not be a subset of path P_{660/560′} P₆₅₀ ⊂ P₆₀₀ even if node 550/650 is an element of P₅₆₀ (i.e., n₅₅₀ ∈ P₅₆₀). The routing decision is thus dynamic as the packet progresses from node to node toward the destination node. FIGS. 10-11 illustrates one embodiment of a method of dynamically determining the next node based at least in part on remaining battery life.

FIG. 10 illustrates one embodiment of a method of determining a first selected path from an originating node to a destination node based at least in part on a cumulative function of the remaining battery life for each sensor node in the path. A plurality of communicatively coupled sensor nodes including a destination node is provided in step 1010. A first selected path from an originating node to the destination node is determined from any plurality of possible paths based on a cost of the first selected path in step 1020. The cost of any path is a cumulative function based at least in part on the remaining battery life for each sensor node in that path.

FIG. 11 illustrates one embodiment of a method of communicating a packet to the next node of the first selected path to next node of a second selected path. A packet is communicated from an originating node to a next node of the first selected path in step 1110. A second selected path from the next node of the first selected path to the destination node is determined from any plurality of possible paths based on a cost of the second selected path in step 1120. The cost of any path is based at least in part on a cumulative function of for each sensor node in that path. In step 1130, the packet is communicated from the next node of the first selected path to the next node of the second selected path.

Various methods and apparatus for routing communications in a sensor node network are provided. Communications are routed between sensor nodes to a destination node based on a routing metric. The routing metric is based at least in part on a remaining battery life of the sensor nodes.

In the preceding detailed description, embodiments of the invention are described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
a) providing a plurality of communicatively coupled sensor nodes including a destination node; and
b) determining a first selected path from an originating node to the destination node from any plurality of possible paths based on a cost of the first selected path, wherein the cost of any path is based at least in part on a cumulative function of the remaining battery life for each sensor node in that path.

2. The method of claim 1 further comprising:
c) communicating a packet from the originating node to a next node of the first selected path.

3. The method of claim 2 further comprising:
d) determining a second selected path from the next node of the first selected path to the destination node from any plurality of possible paths based on a cost of the second selected path, wherein the cost of any path is a cumulative function of the remaining battery life for each node in that path; and
e) forwarding the packet from the next node of the first selected path to a next node of the second selected path.

4. The method of claim 3 wherein the second selected path is a proper subset of the first selected path.

5. The method of claim 3 wherein the second selected path is not a proper subset of the first selected path.

6. The method of claim 1 wherein the remaining battery life is the only parameter for the cost function.

7. The method of claim 1 wherein the cost for each node i of any path is selected from one of
$${c}_{i} ( {b}_{i} ) = \frac{W {1}_{i}}{{b}_{i}} , \\ {c}_{i} ( {b}_{i} ) = \frac{W {1}_{i}}{{b}_{i} + {K}_{i}} ,$$
and cᵢ(bᵢ)=Mᵢ−bᵢ, wherein W1ᵢ is a weight and bᵢ is a remaining battery life attributable to that node, Kᵢ is selected to constrain cᵢ(bᵢ) as bᵢ approaches zero, and Mᵢ is greater than or equal to the maximum battery capacity to ensure non-negative values for cᵢ(bᵢ).

8. The method of claim 7 wherein the cost associated with the selected path
$${C}_{s} = {\sum }_{i = 1}^{n} {c}_{i} ( {b}_{i} ) .$$

9. The method of claim 1 wherein the cost is a function of both remaining battery life and path length, wherein path length is a number of edges from the origination node to the destination node along the selected path.

10. The method of claim 1 wherein one or more nodes sense at least one of an air temperature, pressure, wind speed, wind direction, probability and amount of precipitation, humidity, cloud cover, visibility, heat index, wind chill, drought index, soil moisture, aerosol dispersion, ranges of electromagnetic radiation, earth movement, vibration, and motion.

11. The method of claim 8 wherein the electromagnetic radiation is in a range of at least one of a radio, microwave, infrared, visible light, ultraviolet, X-ray, or gamma ray radiation.

12. The method of claim 1 wherein the plurality of sensor nodes uses one of a link-state protocol and a distance-vector protocol.

13. An apparatus comprising:
a plurality of communicatively coupled sensor nodes including a destination node, wherein each sensor node includes a processor, wherein the processor selects a first selected path from an originating node to the destination node from any plurality of possible paths based on a cost of the first selected path, wherein the cost of any path is based at least in part on a cumulative function of the remaining battery life for each node in that path.

14. The apparatus of claim 13 wherein the remaining battery life is the only parameter for the cost function.

15. The apparatus of claim 13 wherein the cost for every node i of any path is proportional to one of
$${c}_{i} ( {b}_{i} ) = \frac{1}{{b}_{i}} , \\ {c}_{i} ( {b}_{i} ) = \frac{1}{{b}_{i} + {K}_{i}} ,$$
and cᵢ(bᵢ)=Mᵢ−bᵢ, wherein bᵢ is a remaining battery life attributable to that node, Kᵢ is selected to constrain cᵢ(bᵢ ) as bᵢ approaches zero, and Mᵢ is greater than or equal to the maximum battery capacity to ensure non-negative values for cᵢ(bᵢ) for node i.

16. The apparatus of claim 15 wherein
$${C}_{s} = {\sum }_{i = 1}^{n} {c}_{i} ( {b}_{i} ) ,$$
wherein Cₛ is the cost associated with the selected path.

17. The apparatus of claim 13 wherein
$${C}_{s} = nW 2 + W 1 {\sum }_{i = 1}^{n} {c}_{i} ( {b}_{i} ) ,$$
wherein Cₛ is the cost associated with the selected path, wherein W1 and W2 are weight factors and n is a path length of the selected path, wherein cᵢ(bᵢ) is the cost for node i along the selected path, wherein bᵢ is a remaining battery life attributable to node i.

18. The apparatus of claim 17 wherein the cost for every node i of any path is proportional to one of
$${c}_{i} ( {b}_{i} ) = \frac{1}{{b}_{i}} , \\ {c}_{i} ( {b}_{i} ) = \frac{1}{{b}_{i} + {K}_{i}} ,$$
and cᵢ(bᵢ)=Mᵢ−bᵢ, wherein Kᵢ is selected to constrain cᵢ(bᵢ) as bᵢ approaches zero, and Mᵢ is greater than or equal to the maximum battery capacity to ensure non-negative values for cᵢ(bᵢ) for node i.

19. The apparatus of claim 13 wherein one or more nodes sense at least one of an air temperature, pressure, wind speed, wind direction, probability and amount of precipitation, humidity, cloud cover, visibility, heat index, wind chill, drought index, soil moisture, aerosol dispersion, ranges of electromagnetic radiation, earth movement, vibration, and motion.

19. The method of claim 13 wherein the plurality of sensor nodes is wirelessly communicatively coupled.

20. The apparatus of claim 13 wherein the plurality of sensor nodes uses one of a link-state routing protocol and a distance-vector routing protocol.
